(19) United States
(12) Patent Application Publication
(10) Pub. No.: US 2025/0101926 A1
(43) Pub. Date: Mar. 27, 2025

(54) DUAL FUEL SYSTEM FOR ENGINE HAVING FUEL-ACTUATED FUEL PUMP AND METHOD

(71) Applicant: Caterpillar Inc., Peoria, IL (US)

(72) Inventors: Hoisan Kim, Dunlap, IL (US); Jack A. Merchant, West Lafayette, IN (US)

(73) Assignee: Caterpillar Inc., Peoria, IL (US)

(21) Appl. No.: 18/373,396

(22) Filed: Sep. 27, 2023

(51) Int. Cl. F02D 19/06

(52) U.S. Cl. CPC F02D 19/0684; F02D 19/0649; F02D 19/0681

(57) ABSTRACT

A dual fuel system includes a first pressurized fuel reservoir, a first fuel pump fluidly connected to the first pressurized fuel reservoir, a second pressurized fuel reservoir, and a second fuel pump including a pump outlet fluidly connected to the second pressurized fuel reservoir, a pumping chamber, an actuating fluid inlet fluidly connected to at least one of the first fuel pump or the first pressurized fuel reservoir, and at least one pumping element. The first fuel pump may have excess capacity, at least at times, so as to provide a pressurized first fuel for actuating the second fuel pump. The at least one pumping element may include an intensifier or de-intensifier plunger such that a flow rate of a second pressurized fuel from the second fuel pump is different than a flow rate of the first pressurized fuel from the first fuel pump as an actuating fluid for the second fuel pump. Related apparatus and methodology is also disclosed.

### TECHNICAL FIELD

The present disclosure relates generally to a dual fuel system for an internal combustion engine, and more particularly to pressurizing two different fuels whilst using pumped fuel from a first pump to actuate a second pump.

### BACKGROUND

Dual fuel internal combustion engine systems are well known and increasingly adopted throughout the world for purposes ranging from electric power generation to operation of vehicular and industrial equipment. Engineers have discovered many different strategies for advantageously utilizing combustion and emissions characteristics of different types of fuel simultaneously or in different engine cycles in an engine cylinder. In one example dual fuel system a relatively small pilot injection of diesel fuel is compression-ignited in a cylinder and used to trigger ignition of a larger, main charge of a gaseous fuel such as natural gas. Other known strategies seek to utilize two different types of liquid fuels, such as diesel fuel and an alcohol fuel such as methanol. Factors driving continued research and development of dual fuel engine systems include a desire for reduced emissions of certain types, fuel economy, and cost.

A significant drawback to certain dual fuel engine implementations is a need for apparatus to supply, contain, pressurize and manage two different types of fuel. In a typical example, two separate and independent pumping systems are required for the two different fuel types, each including a low pressure transfer pump, and a high pressure pump commonly driven off of the engine geartrain. Injection pressures in dual fuel applications can be quite high necessitating relatively large and heavy-duty pumps that can take up considerable space as well as increasing costs. One known dual fuel system is set forth in U.S. Pat. No. 9,664,122 B2 to Coldren et al.

### SUMMARY

In one aspect, a dual fuel system includes a first pressurized fuel reservoir, a first fuel pump fluidly connected to the first pressurized fuel reservoir, a second pressurized fuel reservoir, and a second fuel pump. The second fuel pump includes a pump outlet fluidly connected to the second pressurized fuel reservoir, a pumping chamber fluidly connected to the pump outlet, an actuating fluid inlet fluidly connected to at least one of the first fuel pump or the first pressurized fuel reservoir, and at least one pumping element. The at least one pumping element includes an actuating surface exposed to a fluid pressure of the actuating fluid inlet, and a pumping surface exposed to the pumping chamber.

In another aspect, a method of operating a dual fuel system includes feeding a pressurized first fuel from a first fuel pump to a first pressurized fuel reservoir, and feeding the pressurized first fuel to an actuating fluid inlet of a second fuel pump. The method further includes actuating the second fuel pump via the pressurized first fuel to pressurize a second fuel, and feeding the pressurized second fuel to a second pressurized fuel reservoir. The method further includes injecting, into each of a plurality of cylinders in an engine, the pressurized first fuel and the pressurized second fuel from a first fuel outlet set and a second fuel outlet set, respectively, each formed in at least one fuel injector.

In still another aspect, a dual fuel engine system includes an engine having a plurality of cylinders formed therein, and a fuel system including a first pressurized fuel reservoir, a first fuel pump fluidly connected to the first pressurized fuel reservoir, a second pressurized fuel reservoir, and a second fuel pump fluidly connected to the second pressurized fuel reservoir. The fuel system further includes at least one fuel injection nozzle assembly within each cylinder and each forming a first fuel outlet set and a second fuel outlet set structured to fluidly connect, respectively, to the first pressurized fuel reservoir and the second pressurized fuel reservoir. The second fuel pump further includes a plurality of hydraulically actuated pumping elements each including an actuation surface, an actuating fluid inlet fluidly connected to the first fuel pump, and a plurality of electrically actuated flow control valves each positioned fluidly between the actuating fluid inlet and the actuation surface of one of the plurality of hydraulically actuated pumping elements.

In still another aspect, a fuel pump includes a pump housing having formed therein each of an actuating fluid inlet, an actuating fluid drain, a valve seat positioned fluidly between the actuating fluid inlet and the actuating fluid outlet, a pumped fuel inlet, a pumping chamber, and a pumped fuel outlet. The fuel pump further includes a flow control valve movable between a closed position blocking the valve seat, and an open position, and at least one pumping element including an actuating surface having a lesser area and exposed to a fluid pressure of the actuating fluid inlet, and a pumping surface having a greater area and exposed to the pumping chamber.

In still another aspect, a fuel pump includes a pump housing having formed therein each of an actuating fluid inlet, an actuating fluid drain, a valve seat positioned fluidly between the actuating fluid inlet and the actuating fluid outlet, a pumped fuel inlet, a pumping chamber, and a pumped fuel outlet. The fuel pump further includes a flow control valve movable between a closed position blocking the valve seat, and an open position, and at least one pumping element. The at least one pumping element includes an actuating surface having a lesser area and exposed to a fluid pressure of the actuating fluid inlet, and a pumping surface having a greater area and exposed to the pumping chamber.

### BRIEF DESCRIPTION OF DRAWINGS

FIG. 1 is a diagrammatic view of a dual fuel engine system, according to one embodiment;

FIG. 2 is a sectioned side diagrammatic view of portions of a dual fuel engine system as in FIG. 1;

FIG. 3 is a sectioned side diagrammatic view of a fuel pump, according to one embodiment;

FIG. 4 is a sectioned side diagrammatic view of a pump unit suitable for use in the fuel pump of FIG. 3;

FIG. 5 is a diagrammatic view of a plurality of fuel pumps supported in a housing, according to one embodiment;

FIG. 6 is a sectioned side diagrammatic view of a fuel pump, according to one embodiment; and

FIG. 7 is a diagrammatic view of the fuel pump of FIG. 6.

### DETAILED DESCRIPTION

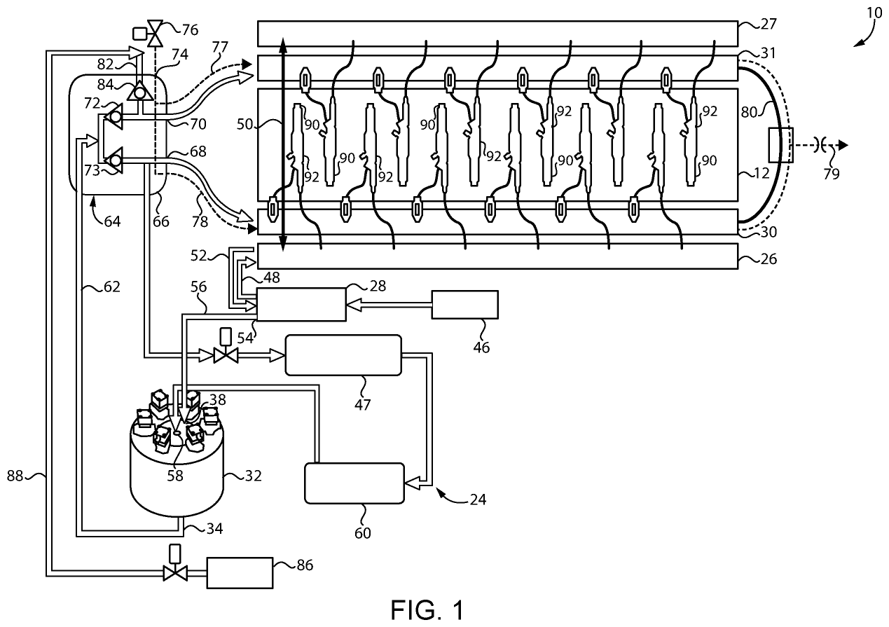

Referring to FIG. 1, there is shown a dual fuel internal combustion system engine 10 according to one embodiment. Engine system 10 includes an internal combustion engine 12 and a dual fuel system 24. Engine 12 can be operated to power a load such as an electrical generator, a pump, a compressor, or a driveline in a mobile machine such as a marine vessel. Additional apparatus relating to an air intake system, an exhaust system, an engine geartrain, and various other components and subsystems of engine system 10 are not shown explicitly in FIG. 1 but will be understood as conventionally included. Engine system 10 can be operated on a variety of different fuel types including a compression-ignition liquid fuel such as a diesel distillate fuel and an alcohol fuel such as methanol, gasoline, naphtha, as well as various blends. In some embodiments, engine system 10 could be operated on a compression-ignition liquid fuel and a gaseous fuel such as natural gas. As will be further apparent from the following description, engine system 10 may be configured for improved efficiency and reduced overall packaging footprint as compared to certain known designs.

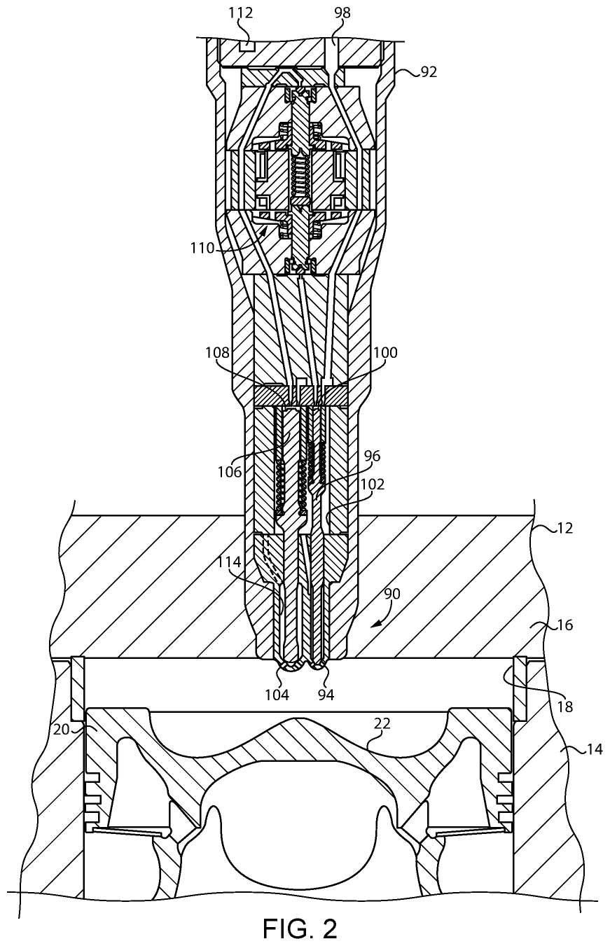

Referring also to FIG. 2, engine 12 includes a cylinder block 14 having a plurality of cylinders 18 formed therein, one of which is illustrated in FIG. 2. A cylinder head 16 is attached to cylinder block 14 and will conventionally include one or more intake valves and one or more exhaust valves associated with each respective cylinder 18. Engine 12 also includes a plurality of pistons 20 one of which is shown in FIG. 2 and movable between a top-dead-center position and a bottom-dead-center position, typically in a four-stroke engine cycle, to increase a pressure of fluids in cylinder 18 to an autoignition threshold. The plurality of cylinders 18 can include any number in any suitable arrangement such as an in-line pattern, a V-pattern, or still another. Each piston 20 may include a combustion bowl 22 approximately as illustrated in FIG. 2, although the present disclosure is not thereby limited.

Focusing now on additional features of dual fuel system 24, fuel system 24 includes a first pressurized fuel reservoir 26 and a first fuel pump 28 fluidly connected to first pressurized fuel reservoir 26. Fuel system 24 may also include another pressurized fuel reservoir 27 which may be referred to herein as a fourth pressurized fuel reservoir. Fuel system 24 also includes a second pressurized fuel reservoir 30 and a second fuel pump 32 including a pump outlet 34 fluidly connected to second pressurized fuel reservoir 30. Fuel system 24 may further include a third pressurized fuel reservoir 31 also fluidly connected to second fuel pump 32. The terms “first,” “second,” “third,” and other numerical descriptors are not used herein to prescribe any ordering or identity of components and are purely for descriptive convenience. In the embodiment illustrated in FIG. 1 first and second pressurized fuel reservoirs 26 and 30 may each contain a different pressurized fuel for injection to a first group or subset of cylinders 18, and third and fourth pressurized fuel reservoirs 31 and 27 may analogously feed two fuels to a second group or subset of cylinders 18. The pressurized fuel reservoirs may be positioned at opposite sides of engine 12 in some embodiments approximately as shown in FIG. 1.

Fuel system 24 may further include a first fuel supply conduit 48 extending from first fuel pump 28 to first pressurized fuel reservoir 26. A connecting conduit 50 may fluidly connect first pressurized fuel reservoir 26 to fourth pressurized fuel reservoir 27. A drain conduit 52 may extend from first pressurized fuel reservoir 26 back to first fuel pump 28. A first fuel supply 46 contains a compression-ignition liquid fuel, such as a diesel distillate fuel, that is supplied to first fuel pump 28. First fuel pump 28 may include a high pressure fuel pump that receives a feed of fuel from a low pressure transfer pump positioned fluidly between first fuel supply 46 and first fuel pump 28. In an embodiment, first fuel pump 28 can be operated via a geartrain (not shown) of engine 12.

First fuel pump 28 may also include a high pressure pump outlet 54. Pump outlet 54 fluidly connects to an actuating fluid conduit 56 extending to an actuating fluid inlet 38 of second fuel pump 32, the significance of which will be further apparent from the following description.

Second fuel pump 32 also includes a pump inlet or a fuel inlet 58 that receives a feed of a second fuel from a low-pressure transfer pump 60 fluidly connected to a second fuel supply 47. Second fuel supply 47 contains a second fuel, such as a liquid alcohol fuel including methanol or various blends, commonly but not necessarily with methanol predominating. An outlet conduit 62 extends from pump outlet 34 to a fuel manifold 64. Fuel manifold 64 is positioned fluidly between second fuel pump 34 and each of second pressurized fuel reservoir 30 and third pressurized fuel reservoir 31. Fuel manifold 64 includes a housing 66 having two fuel outlets, including a first fuel outlet 68 fluidly connected to second pressurized fuel reservoir 30, and a second fuel outlet 70 fluidly connected to third pressurized fuel reservoir 31. A first check valve 72 and a second check valve 73 may be within manifold housing 66 and positioned fluidly between outlet conduit 62 and first pressurized fuel reservoir 30 and third pressurized fuel reservoir 31, respectively, approximately as depicted in FIG. 1.

Fuel manifold 64 may also include an air inlet 74 receiving a feed of air from an electronically controlled air control valve 76. Pressurized fuel reservoirs as contemplated herein may include so-called double wall reservoirs or common rails each arranged to feed pressurized fuel to a plurality of cylinders in an engine, and where a flow of air is conveyed through an outer, lower pressure passage or conduit so as to capture any fuel leakage for returning to second fuel supply 47, for example. Air conduits 77 and 78 may extend from fuel manifold 64 to pressurized fuel reservoirs 30 and 31. An air outlet 79 receives a flow of air passed through the double walled structures.

Fuel system 24 may also include a purging gas supply 86, such as a supply of nitrogen, and a purging gas conduit 88 that extends from purging gas supply 86 to a purging gas inlet 82 of fuel manifold 64. Fuel manifold 64 may also include a purging gas valve 84 positioned fluidly between purging gas inlet 82 and at least one of second pressurized fuel reservoir 30 and third pressurized fuel reservoir 31. A connector conduit 80 fluidly connects second pressurized fuel reservoir 30 to third pressurized fuel reservoir 31.

Fuel system 24 also includes a plurality of fuel injection nozzle assemblies 90 in a plurality of fuel injectors 92. Each cylinder 18 in engine system 10 may include one fuel injector operable to selectively inject one or both of the first fuel and the second fuel, or two separate fuel injectors operable to selectively inject the first fuel and the second fuel. Embodiments are contemplated where a single fuel injector includes dual concentric checks operable to respectively inject the two fuels, as well as embodiments as shown in FIG. 2 where side-by-side dual checks are used. Each cylinder 18 in engine 12 will be associated with at least one fuel injection nozzle assembly that includes a first fuel outlet set 94, a first injection valve 96 movable to open and close the respective first fuel outlet set 94 to first pressurized fuel reservoir 26 or fourth pressurized fuel reservoir 27, a second fuel outlet set 104, and a second injection valve 106 movable to open and close second fuel outlet set 104 to second pressurized fuel reservoir 30 or third pressurized fuel reservoir.

In the embodiment shown, fuel injector 92 includes a first fuel inlet 98 that receives a feed of the first fuel from first pressurized fuel reservoir 26, and a second fuel inlet 112 that receives a feed of the second fuel from second pressurized fuel reservoir 30. A fuel chamber 102 is formed in fuel injector 92 and fluidly connected to first fuel inlet 98, and fluidly connects to first fuel outlet set 94 when first injection valve 96 is opened. A second fuel chamber 114 fluidly connects to fuel inlet 112 and is fluidly connected to second fuel outlet set 104 when second injection valve 106 is opened. First fuel injection valve 96 includes a hydraulic control surface 100 exposed to a fluid pressure of first pressurized fuel reservoir 26. Second injection valve 106 includes a hydraulic control surface 108 exposed to a fluid pressure of first pressurized fuel reservoir 26. In this way, it will be appreciated that each of first fuel injection valve 96 and second fuel injection valve 106 is controlled at least in part based on a fuel pressure of the first fuel contained in first pressurized fuel reservoir 26 (or fourth pressurized fuel reservoir 27 if used), and typically including diesel. Fuel injector 92 also includes an injection control valve assembly 110. Injection control valve assembly 110 is electrically actuated, and can include two solenoid actuators to separately and independently vary a closing hydraulic pressure on hydraulic control surfaces 100 and 108 to control a start of injection timing, an end of injection timing, an injection quantity and potentially other characteristics of fuel injection.

It will be recalled that the first fuel may be a diesel distillate fuel, and the second fuel may be an alcohol fuel such as methanol. Diesel fuels are more energy dense than methanol, typically requiring a relatively larger fuel injection quantity for a given engine power output. Engine system 10 can be operated in a diesel-only mode, or a pilot-ignited dual fuel mode. In the diesel-only mode the engine power output requirements are satisfied by compression-ignition combustion of solely diesel fuel. Operating in such a mode includes injecting only diesel fuel using only injection valve 96. In the dual fuel mode a relatively small diesel pilot injection is delivered into cylinder 18 to compression ignite a larger charge or injection of methanol using injection valve 106. Fuel injector 92 will typically be designed such that each respective first fuel outlet set 94 and first injection valve 96 in the respective nozzle assembly 90 together define a lesser nozzle steady flow, and each respective second fuel outlet set 104 and second injection valve 106 together define a greater nozzle steady flow. Steady flow, including nozzle steady flow, is a well-known attribute respecting fuel injectors, and refers to a flow rate that can be expected given equivalent conditions. Thus, for a given fuel pressure and a given open time a greater quantity of fuel could be expected to inject through second fuel outlet set 104 having a greater steady flow as compared to a nozzle steady flow of first fuel outlet set 94. Individual fuel spray outlets or orifices in second fuel outlet set 104 may be larger in size and/or larger in number than size and/or number of the individual outlets in first fuel outlet set 94.

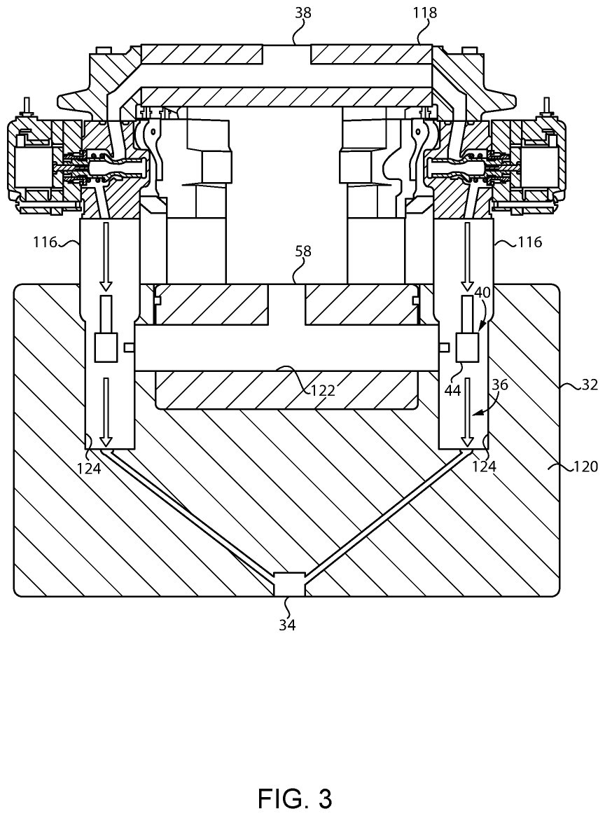

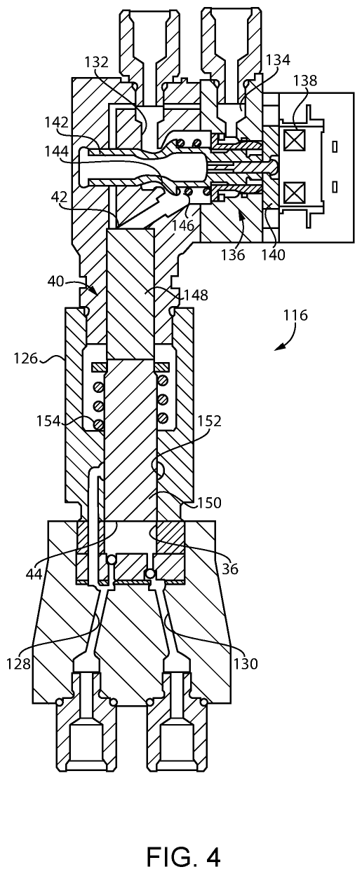

Focusing now on features of second fuel pump 32, and referring also to FIGS. 3 and 4, it will be recalled second fuel pump 32 includes a pump outlet 34 fluidly connected to second pressurized fuel reservoir 30. Second fuel pump 32 also includes a pumping chamber 36 fluidly connected to pump outlet 34, actuating fluid inlet 38 fluidly connected to at least one of first fuel pump 28 or first pressurized fuel reservoir 26, and at least one pumping element 40 having an actuating surface 42 exposed to a fluid pressure of actuating fluid inlet 38, and a pumping surface 44 exposed to pumping chamber 36.

In the illustrated embodiment, second fuel pump 32 includes a plurality of individual pump units 116 positioned within a plurality of pump unit bores 124 formed in a pump body 120. Pump units 116 may be arranged in any suitable pattern, including an approximately circular arrangement as shown, in-line, or in two separate banks or the like. Pump units 116 may be six in number as shown, or include a lesser number such as four or five or a greater number such as seven or eight. Pump body 120 may include therein fuel inlet 58 and a centrally located fuel cavity 122 that fluidly connects fuel inlet 58 to each individual pump unit 116. Second fuel pump 32 may also include an actuating fluid manifold 118 that includes actuating fluid inlet 38 formed therein. Actuating fluid manifold 118 may be attached to each of pump units 116 which may have a generally circumferential distribution in pump body 120 around centrally located pump 58 as shown, or another arrangement as discussed above.

FIG. 4 shows an example one of pump units 116 in further detail, including a pump unit housing 126 forming a fuel inlet passage 128 to pumping chamber 36 and a pressurized fuel outlet passage 130 extending from pumping chamber 36 to fuel outlet 34. Pump unit housing 126 also forms an actuating fluid inlet passage 132, an actuating fluid drain passage 134, and includes therein or thereon a flow control valve assembly 136. Flow control valve assembly 136 includes an electrical actuator 138, such as a solenoid actuator, coupled to an armature 140 in turn coupled to an electrically actuated flow control valve 142. Electrically actuated flow control valve 142 may be positioned fluidly between actuating fluid inlet 38 and actuating surface 42. Actuating fluid inlet passage 132 may be understood to form one of a plurality of actuating fluid supply ports in second fuel pump 32 each fluidly connected to one of the plurality of pumping elements 40. Energizing flow control valve assembly 136 can cause flow control valve 142 to open a seat 144 in opposition to a biasing force of a return spring 146. Opening seat 144 enables a flow of pressurized actuating fluid, including the pressurized first fuel, to flow through actuating fluid inlet passage 132 and act on actuating surface 42, driving pumping element 40 downward in a pumping stroke to pressurize the second fuel in pumping chamber 36.

As noted above, a flow of the second fuel is desirably greater than a flow rate of the first fuel based at least in part upon the lesser energy density of the second fuel. To enable a flow rate of the second fuel from second fuel pump 32 that is greater than a flow rate of the first fuel acting as actuation fluid, the at least one pumping element 40 may include a reverse intensifier plunger wherein actuating surface 42 has a first area and pumping surface 44 has a second area different from, such as larger, than the first area. In other embodiments rather than reverse intensifying or de-intensifying, the pumped second fuel may be intensified in pressure. A pumped second fuel de-intensified in pressure might be a fuel having an energy density greater than the first fuel used as an actuation fluid. In still other instances, the first fuel and second fuel could have similar or substantially equal energy densities, in which case no intensification at all might be used and a ratio of flow of the first fuel used for actuation to the pumped second fuel might be approximately 1:1.

Pumping element 40 and each of the other pumping elements in other pump units 116, may include a two-piece plunger having a first plunger piece 148 with actuating surface 42 formed thereon and a separate second plunger piece 150 having pumping surface 44 thereon. A single plunger piece having the respective surfaces differing in area could also be used. In this way, a relatively lesser flow rate of the first fuel produces a relatively greater flow rate of the second fuel. An annulus 152 may be formed in pump unit housing 126 and extends around second plunger piece 150 for lubrication and collection of fuel that escapes past a clearance between second plunger piece 150 and pump unit housing 126. Annulus 152 may fluidly connect to inlet passage 128 as illustrated. Moving pumping element 40 in a pumping stroke, downward in the FIG. 4 illustration, can occur in opposition to a bias of a return spring 154. Suitably arranged check valves (not numbered) may be positioned fluidly between pumping chamber 36 and inlet passage 128 and outlet passage 130, respectively.

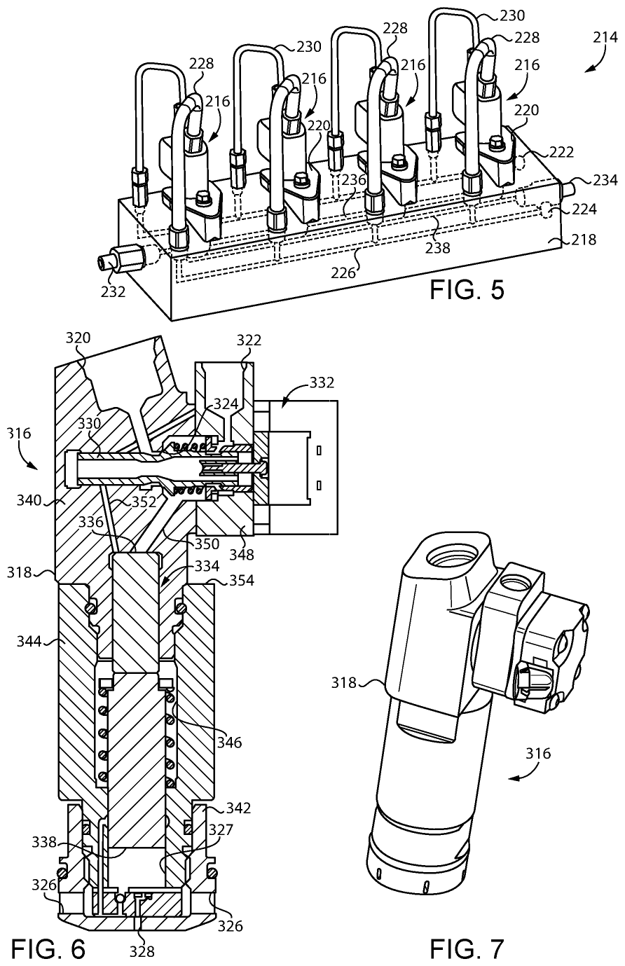

Turning now to FIG. 5, there is shown a pump assembly 214 suitable for use in a fuel system as contemplated herein, including a plurality of pump units 216 supported in a common housing 218. A plurality of clamps 220 are each provided for clamping pump units 216 generally in an in-line configuration in pump assembly 214. Clamps 220 may be fastened by way of any suitable fasteners to pump housing 218. An actuating fluid inlet 224 is formed in pump housing 218 and may receive a feed of pressurized fluid for actuation, such as a feed of pressurized fuel from first fuel pump 47 in the system shown in FIG. 1. An actuating fluid outlet 222 or drain is also formed in housing 218. A common actuating fluid passage 226 extends through housing 218 and provides a feed of the pressurized fuel for actuation to a plurality of actuating fluid supply conduits 228 each extending from housing 218 to one of pump units 216. A plurality of actuating fluid drain conduits 230 extend from pump units 216 back to housing 218 for collection of spent actuating fuel and supplying to actuating fluid outlet 222. Other arrangements of conduits, plumbing, and pump unit arrangement are within the scope of the present disclosure. A pumped fuel inlet fitting 323 forms a pumped fuel inlet and is coupled to housing 218 to convey a feed of fuel for pressurization, such as an alcohol fuel discussed herein, to a common pumped fuel supply passage 236. A pumped fuel outlet passage 238 receives feeds of pressurized fuel from each respective pump unit 216 and commonly feeds the same to a pumped fuel outlet fitting 238. Pumped fuel outlet fitting 238 forms a pumped fuel outlet to supply the now pressurized fuel to a plurality of fuel injectors, such as by way of a pressurized fuel reservoir in some embodiments.

Referring now to FIGS. 6 and 7, there are shown features of a fuel pump or pump unit 316 similar to or potentially identical to pump units 216 shown in FIG. 5. Fuel pump 316 includes a pump housing 318 having formed therein each of an actuating fluid inlet 320 and an actuating fluid drain 322. Pump housing 318 also has formed therein a valve seat 324 positioned fluidly between actuating fluid inlet 320 and actuating fluid drain 322. Pump housing 318 further includes formed therein a pumped fuel inlet 326, a pumping chamber 327, and a pumped fuel outlet 328. A flow control valve 330 is positioned in pump housing 318 and movable between a closed position blocking valve seat 324, and an open position not blocking valve 324, generally analogous to other flow control valves discussed and contemplated herein. Fuel pump 316 also includes an electrical actuator assembly 332, again similar or identical to analogous assemblies discussed herein, and operable to move flow control valve 330 between its respective open position and closed position. Fuel pump 316 further includes at least one pumping element 334. Pumping element 334 includes an actuating surface 336 having a lesser area and exposed to a fluid pressure of actuating fluid inlet 320, and a pumping surface 338 having a greater area and exposed to pumping chamber 327. Operation of fuel pump 316 to amplify a flow of a second fuel by way of actuation of pumping element 334 using a first fuel is generally analogous to that of other embodiments discussed and contemplated herein.

In the illustrated example, pump housing 318 further includes a valve body piece 340. Valve body piece 340 may have formed therein actuating fluid inlet 320, and valve seat 324. Pump housing 318 may also include a pumping piece 342 having pumped fuel inlet 326 formed therein and pumped fuel outlet 328 formed therein. Also in the illustrated example, a plurality of pumped fuel inlets and generally extend along radial directions relative to a reciprocation direction defined by pumping element 334. A single, centrally located pumped fuel outlet 328 may be provided as shown. The present disclosure is not thereby limited, however, and other arrangements and configurations of pumped fuel inlets and outlets are contemplated. Pumped fuel inlet or inlets 326 can receive fuel from a common supply conduit such as pumped fuel supply passage 236. Pump housing 318 may also include a middle piece 334 forming a plunger bore 346 receiving pumping element 334. In the illustrated example plunger bore 346 is formed in part by each of valve body piece 340, pumping piece 342, and middle piece 344. Middle piece 344 may include a clamping surface 354 positioned to be engaged by a clamp such as one of clamps 220 shown in the FIG. 5 illustration. Pump housing 318 may further include a drain piece 348 sandwiched between electrical actuator assembly 332 and valve body piece 340 and having outlet 322 formed therein. A first passage 350 extends in valve body piece 340 to convey a flow of pressurized fuel past valve seat 324 for actuation of pumping element 334 when flow control valve 330 is open. A second passage 352 extends generally from actuating surface 336 to actuating fluid drain 322. Also in the illustrated embodiment, pumping element 334 includes a two-piece pumping element having a first plunger piece 356 and a second plunger piece 358 that contact one another but are not otherwise physically connected. A single-piece plunger is also within the scope of the present disclosure.

### INDUSTRIAL APPLICABILITY

Referring to the drawings generally, but focusing on the embodiment of FIG. 1, as discussed above engine system 10 can be operated in multiple different modes, including a dual fuel mode where a relatively small pilot injection of the first fuel is compression ignited to ignite a larger injection of the second fuel in cylinder 18. It remains desirable for engine system 10 to be capable of operating in a single fuel, diesel-only mode. For this reason, first fuel pump 28 will typically be configured with sufficient capacity to operate engine system 10 solely upon diesel across a full speed and load range. This means that, at times, and including in a dual fuel mode, first fuel pump 28 has extra capacity meaning first fuel pump 28 can be operated to pressurize the first fuel in first pressurized fuel reservoir 26, and also supply the first fuel for actuation of second fuel pump 32.

In a dual fuel mode, operating dual fuel system 24 can include feeding the pressurized first fuel from first fuel pump 28 to first pressurized fuel reservoir 26, and feeding the pressurized first fuel to actuating fluid inlet 38 of second fuel pump 32. Actuating second fuel pump 32 via the pressurized first fuel pressurizes the second fuel, which can be fed to second pressurized fuel reservoir 30. With both respective pressurized fuel reservoirs pressurized the pressurized first fuel and the pressurized second fuel can be injected into each of a plurality of cylinders 18 in engine 12 via first fuel outlet set 94 and second fuel outlet set 104, respectively. The pressurized first fuel can be injected in a relatively small pilot charge in a pilot quantity just prior to a top dead center position of the respective piston 20, to compression ignite the pressurized second fuel typically delivered in a second injection of a larger quantity shortly following the pilot injection. As discussed herein, feeding the pressurized first fuel can include feeding the pressurized first fuel at a first flow rate and feeding the pressurized second fuel can include feeding the pressurized second fuel at a second flow rate that is greater than the first flow rate. An outlet pressure of first fuel pump 28 may be greater than an outlet pressure of second fuel pump 32, and an injection pressure of the first fuel may be greater than an injection pressure of the second fuel.

The present description is for illustrative purposes only, and should not be construed to narrow the breadth of the present disclosure in any way. Thus, those skilled in the art will appreciate that various modifications might be made to the presently disclosed embodiments without departing from the full and fair scope and spirit of the present disclosure. Other aspects, features and advantages will be apparent upon an examination of the attached drawings and appended claims. As used herein, the articles “a” and “an” are intended to include one or more items, and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A dual fuel system comprising:
a first pressurized fuel reservoir;
a first fuel pump fluidly connected to the first pressurized fuel reservoir;
a second pressurized fuel reservoir; and
a second fuel pump including a pump outlet fluidly connected to the second pressurized fuel reservoir, a pumping chamber fluidly connected to the pump outlet, an actuating fluid inlet fluidly connected to at least one of the first fuel pump or the first pressurized fuel reservoir, and at least one pumping element having an actuating surface exposed to a fluid pressure of the actuating fluid inlet, and a pumping surface exposed to the pumping chamber.

2. The dual fuel system of claim 1 wherein the at least one pumping element includes a reverse intensifier plunger wherein the actuating surface has a first area and the pumping surface has a second area larger than the first area.

3. The dual fuel system of claim 1 wherein the second fuel pump includes an electrically actuated flow control valve positioned fluidly between the actuating fluid inlet and the actuating surface.

4. The dual fuel system of claim 3 wherein the at least one pumping element includes one of a plurality of pumping elements, and the second fuel pump further includes an actuating fluid manifold including the actuating fluid inlet, and a plurality of actuating fluid supply ports fluidly connected to the plurality of pumping elements.

5. The dual fuel system of claim 1 further comprising a plurality of fuel injection nozzle assemblies each including a first fuel outlet set, a first injection valve movable to open and close the first fuel outlet set to the first pressurized fuel reservoir, a second fuel outlet set, and a second injection valve movable to open and close the second fuel outlet set to the second pressurized fuel reservoir.

6. The dual fuel system of claim 5 wherein each respective first fuel outlet set and first injection valve together define a lesser steady flow, and each respective second fuel outlet set and second injection valve together define a greater steady flow.

7. The dual fuel system of claim 5 wherein each respective first injection valve and second injection valve includes a hydraulic control surface exposed to a fluid pressure of the first pressurized fuel reservoir.

8. The dual fuel system of claim 1 further comprising:
a third pressurized fuel reservoir; and
a fuel manifold positioned fluidly between the second fuel pump and each of the second pressurized fuel reservoir and the third pressurized fuel reservoir.

9. The dual fuel system of claim 8 further comprising a connector conduit fluidly connecting the second pressurized fuel reservoir to the third pressurized fuel reservoir, and wherein the fuel manifold includes a purging gas inlet and a purging gas valve positioned fluidly between the purging gas inlet and at least one of the second pressurized fuel reservoir and the third pressurized fuel reservoir.

10. A method of operating a dual fuel system comprising:
feeding a pressurized first fuel from a first fuel pump to a first pressurized fuel reservoir;
feeding the pressurized first fuel to an actuating fluid inlet of a second fuel pump;
actuating the second fuel pump via the pressurized first fuel to pressurize a second fuel;
feeding the pressurized second fuel to a second pressurized fuel reservoir; and
injecting, into each of a plurality of cylinders in an engine, the pressurized first fuel and the pressurized second fuel from a first fuel outlet set and a second fuel outlet set, respectively, each formed in at least one fuel injector.

11. The method of claim 10 further comprising compression igniting the pressurized first fuel in the plurality of cylinders, and igniting the pressurized second fuel in the plurality of cylinders via the compression ignition of the pressurized first fuel.

12. The method of claim 11 wherein the injecting the pressurized first fuel includes injecting a pilot quantity of the pressurized first fuel, and the injecting the pressurized second fuel includes injecting a larger quantity of the pressurized second fuel.

13. The method of claim 12 wherein the pressurized first fuel includes a diesel fuel, and the pressurized second fuel includes an alcohol fuel.

14. The method of claim 10 wherein the actuating the second fuel pump includes actuating a plunger having an actuation surface exposed to a fluid pressure of the pressurized first fuel, and a pumping surface exposed to a pumping chamber containing the second fuel.

15. The method of claim 14 wherein the feeding the pressurized first fuel includes feeding the pressurized first fuel at a first flow rate, and the feeding the pressurized second fuel includes feeding the pressurized second fuel at a second flow rate that is greater than the first flow rate.

16. The method of claim 15 wherein an outlet pressure of the first fuel pump is greater than an outlet pressure of the second fuel pump.

17. The method of claim 10 further comprising feeding the pressurized second fuel to the second pressurized fuel reservoir and to a third pressurized fuel reservoir via a fuel manifold having a fuel inlet, two fuel outlets fluidly connected, respectively, to the second pressurized fuel reservoir and the third pressurized fuel reservoir, a purging gas inlet, and a purging gas valve positioned fluidly between the purging gas inlet and at least one of the two fuel outlets.

18. A dual fuel engine system comprising:
an engine having a plurality of cylinders formed therein;
a fuel system including a first pressurized fuel reservoir, a first fuel pump fluidly connected to the first pressurized fuel reservoir, a second pressurized fuel reservoir, and a second fuel pump fluidly connected to the second pressurized fuel reservoir;
the fuel system further including at least one fuel injection nozzle assembly within each cylinder and each forming a first fuel outlet set and a second fuel outlet set structured to fluidly connect, respectively, to the first pressurized fuel reservoir and the second pressurized fuel reservoir; and
the second fuel pump further including a plurality of hydraulically actuated pumping elements each including an actuation surface, an actuating fluid inlet fluidly connected to the first fuel pump, and a plurality of electrically actuated flow control valves each positioned fluidly between the actuating fluid inlet and the actuation surface of one of the plurality of hydraulically actuated pumping elements.

19. The dual fuel engine system of claim 18 wherein each actuation surface includes a first area, and each of the plurality of hydraulically actuated pumping elements includes a pumping surface having a second area larger than the respective first area.

20. The dual fuel engine system of claim 18 wherein the at least one fuel injection nozzle assembly includes a first injection valve movable to open and close the first fuel outlet set, and a second injection valve movable to open and close the second fuel outlet set, and each respective first injection valve and second injection valve includes a hydraulic control surface exposed to a fluid pressure of the first pressurized fuel reservoir.

21. A fuel pump comprising:
a pump housing having formed therein each of an actuating fluid inlet, an actuating fluid drain, a valve seat positioned fluidly between the actuating fluid inlet and the actuating fluid outlet, a pumped fuel inlet, a pumping chamber, and a pumped fuel outlet;
a flow control valve movable between a closed position blocking the valve seat, and an open position; and
at least one pumping element including an actuating surface having a lesser area and exposed to a fluid pressure of the actuating fluid inlet, and a pumping surface having a greater area and exposed to the pumping chamber.

22. The fuel pump of claim 21 wherein the at least one pumping element includes a plunger.

23. The fuel pump of claim 22 wherein the plunger includes a two-piece plunger.

24. The fuel pump of claim 21 wherein the at least one pumping element is one of a plurality of pumping elements in a plurality of pump units supported in a common housing.

25. The fuel pump of claim 21 wherein the pump housing includes a valve body piece having the actuating fluid inlet and the valve seat therein, a pumping piece having the pumped fuel inlet and the pumped fuel outlet therein, and a middle piece having a plunger bore receiving therein the at least one pumping element.

26. A dual fuel system including the fuel pump of claim 21 and including a low pressure transfer pump, a pressurized fuel reservoir, and a high pressure pump having a pump inlet fluidly connected to the low pressure transfer pump, and a high pressure pump outlet, and the actuating fluid inlet is fluidly connected to at least one of the high pump outlet or the pressurized fuel reservoir.
